(19) United States
(12) Patent Application Publication
(10) Pub. No.: US 2013/0134106 A1
(43) Pub. Date: May 30, 2013

(54) WASTE LIQUID TREATMENT APPARATUS AND WASTE LIQUID TREATMENT METHOD

(71) Applicants: Shogo Suzuki, Kanagawa (JP); Noriaki Okada, Kanagawa (JP); Shozo Murata, Kanagawa (JP); Hideyuki Miyazawa, Kanagawa (JP)

(72) Inventors: Shogo Suzuki, Kanagawa (JP); Noriaki Okada, Kanagawa (JP); Shozo Murata, Kanagawa (JP); Hideyuki Miyazawa, Kanagawa (JP)

(21) Appl. No.: 13/679,030

(22) Filed: Nov. 16, 2012

(30) Foreign Application Priority Data
Nov. 28, 2011 (JP) 2011-259317
Jul. 3, 2012 (JP) 2012-149961

(51) Int. Cl. C02F 1/02

(52) U.S. Cl. CPC C02F 1/025
USPC 210/763; 210/175; 210/149

(57) ABSTRACT

A first decomposition reaction part and a second decomposition reaction part are arranged with respective catalysts of different types from each other, or, of those reaction parts, only the second decomposition reaction part is arranged with a catalyst. In addition, a fluid outlet side of the first decomposition reaction part and a fluid inlet side of the second decomposition reaction part are directly communicated with each other without being narrowed.

### CROSS-REFERENCE TO RELATED APPLICATIONS

The present application claims priority to and incorporates by reference the entire contents of Japanese Patent Application No. 2011-259317 filed in Japan on Nov. 28, 2011 and Japanese Patent Application No. 2012-149961 filed in Japan on Jul. 3, 2012.

### BACKGROUND OF THE INVENTION

1. Field of the Invention

The present invention relates to an apparatus and a method for waste liquid treatment to decompose organic matter in waste liquid by pressurizing and heating the waste liquid containing the organic matter.

2. Description of the Related Art

Conventionally, as a method for purifying waste liquid such as human waste, sewage, community wastewater, livestock excretion, and food plant wastewater, there has generally been used a method of performing biotreatment using activated sludge. However, this method has not been able to treat high-concentration organic solvent waste liquid that hinders activity of microorganisms, without changing the concentration of the liquid, or to treat waste liquid containing fine plastic particles that are not biodegradable. In addition, if waste liquid contains a large amount of organic suspended solids that are not dissolved in the liquid, the activated sludge vigorously multiplies in the waste liquid, thus resulting in increases in the amount of aeration and the amount of excess sludge treatment, thereby causing an increase in cost. Therefore, there has been a necessity of removing, in advance, the suspended solids using physical or chemical treatment such as filtration or coagulating sedimentation.

In recent years, there has been increasing active development of waste liquid treatment apparatuses that decompose the organic matter in the waste liquid in a short period of time by converting water in the waste liquid into a supercritical state or a subcritical state under a high-temperature and high-pressure environment. In a waste liquid treatment apparatus of this type, water in the waste liquid is heated and pressurized to a temperature of 374° C. and a pressure of 22 MPa to be turned into supercritical water having intermediate properties of liquid and gas. Alternatively, the water in the waste liquid is turned into subcritical water having properties slightly closer to liquid than those of the supercritical state, by setting the temperature and the pressure to slightly lower values than those described above. In the supercritical water and in the subcritical water, the organic matter in the fluid is instantaneously dissolved and hydrolyzed, or the organic matter is instantaneously oxidatively decomposed under the presence of oxygen. In addition, ammonium nitrogen is decomposed to be converted into nitrogen gas. Even the high-concentration organic solvent waste liquid and the waste liquid containing the fine plastic particles can be easily purified, which has been impossible with the biotreatment. In addition, even the waste liquid containing a large amount of organic suspended solids can be almost entirely decomposed into water, nitrogen gas, and carbon dioxide by oxidatively decomposing the large amount of organic suspended solids almost completely.

An apparatus described in Japanese Patent Application Laid-open No. 2008-207135 is known as such a waste liquid treatment apparatus. This waste liquid treatment apparatus has, as reactors resistible to high-temperature and high-pressure, a first reactor and a second reactor connected to the first reactor through piping. Waste liquid is first heated and pressurized in the first reactor while being mixed with an oxidizer such as air, and thus, organic matter in the waste liquid is hydrolyzed and oxidatively decomposed. Then, the fluid in which the organic matter such as organic acid still remains after undergoing the decomposition process such as described above is fed into the second reactor. The second reactor is filled therein with a catalyst composed of manganese dioxide and the like for facilitating decomposition of the organic matter and ammonium nitrogen still remaining after undergoing the decomposition process in the first reactor. The fluid fed to the second reactor is mixed with oxygen while being placed in contact with the catalyst under the high-temperature and high-pressure environment, and thereby, the organic matter is oxidatively decomposed to turn into carbon dioxide. In addition, the ammonium nitrogen contained in the fluid turns into nitrogen gas. In this manner, the organic matter and the ammonium nitrogen contained in the waste liquid, and in addition, the organic acid and the ammonium nitrogen produced in the decomposition process of the organic matter are oxidatively decomposed almost completely, and thus converted into carbon dioxide, nitrogen, and water.

This waste liquid treatment apparatus uses two reactors, that is, the first reactor and the second reactor. This is considered to be because of the following reason. That is, this waste liquid treatment apparatus treats waste liquid composed of livestock excretion. The waste liquid composed of livestock excretion has a property of having a very high concentration of ammonium nitrogen. In such waste liquid, the ammonium nitrogen is likely to be incompletely decomposed and thus to remain as residue. Thus, it is considered that the ammonium nitrogen is oxidatively decomposed in a surer manner in the second reactor filled with the catalyst for facilitating the oxidative decomposition of the ammonium nitrogen.

The second reactor can also be considered to be provided not for the purpose of oxidative decomposition of the ammonium nitrogen but for different reasons. For example, in waste liquid containing persistent polychlorinated biphenyl (PCB) and general organic matter such as carbohydrate and protein, only the PCB is likely to be incompletely decomposed and thus to remain as residue. In such waste liquid, the PCB can be oxidatively decomposed in a surer manner by pressurizing and heating the subcritical or supercritical fluid passed through the first reactor while the fluid is placed in contact with the catalyst useful for facilitating the oxidative decomposition of the PCB in the second reactor. Also, organic matter having a high molecular weight can possibly be more efficiently decomposed by the following process. Without supply of the oxidizer into the first reactor, low-molecularization of the organic matter by hydrolysis is brought about in an intensive manner in the first reactor, and then, oxidative decomposition of the low-molecular organic matter is brought about by mixing with the oxidizer in the second reactor.

However, irrespective of what kind of substance is oxidatively decomposed in the second reactor, there has been a problem that the structure of the waste liquid treatment apparatus described in Japanese Patent Application Laid-open No. 2008-207135 requires time and labor for maintenance. Specifically, in the first reactor and the second reactor, inorganic materials, such as alumina, silica, zirconia, and phosphorus, are separated out as some of final products of the oxidative decomposition. In the waste liquid treatment apparatus described in Japanese Patent Application Laid-open No. 2008-207135, as described above, the first reactor and the second reactor are connected to each other with the piping having a much smaller inside diameter than inside diameters of the reactors. The piping is blocked when the inorganic materials are accumulated in the piping. For this reason, the piping needs to be periodically cleaned inside thereof, and thus, time and labor are greatly required.

Note that the same problem can occur even if a structure is employed in which the waste liquid is converted into subcritical fluid instead of being converted into supercritical fluid in the first reactor and the second reactor.

### SUMMARY OF THE INVENTION

It is an object of the present invention to at least partially solve the problems in the conventional technology.

There is needed to provide an apparatus and a method for waste liquid treatment that are capable of improving the ease of maintenance when compared with conventional apparatuses and methods, while being capable of removing substances that has not been completely removed in a first decomposition reaction part such as the first reactor, in a second decomposition reaction part such as the second reactor, in a surer manner.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flow sheet illustrating a waste liquid treatment apparatus and a flow of treatment thereby according to an embodiment of the present invention;

FIG. 2 is a longitudinal sectional view illustrating a reaction vessel of the waste liquid treatment apparatus according to the embodiment of the present invention;

FIG. 3 is a longitudinal sectional view illustrating a reaction vessel of a waste liquid treatment apparatus according to a first modification;

FIG. 4 is a schematic configuration diagram illustrating a waste liquid treatment apparatus according to a second modification; and

FIG. 5 is a longitudinal sectional view illustrating a reaction vessel of the waste liquid treatment apparatus according to the second modification.

### DETAILED DESCRIPTION OF THE PREFERRED EMBODIMENTS

An embodiment of a waste liquid treatment apparatus to which the present invention is applied will be described below.

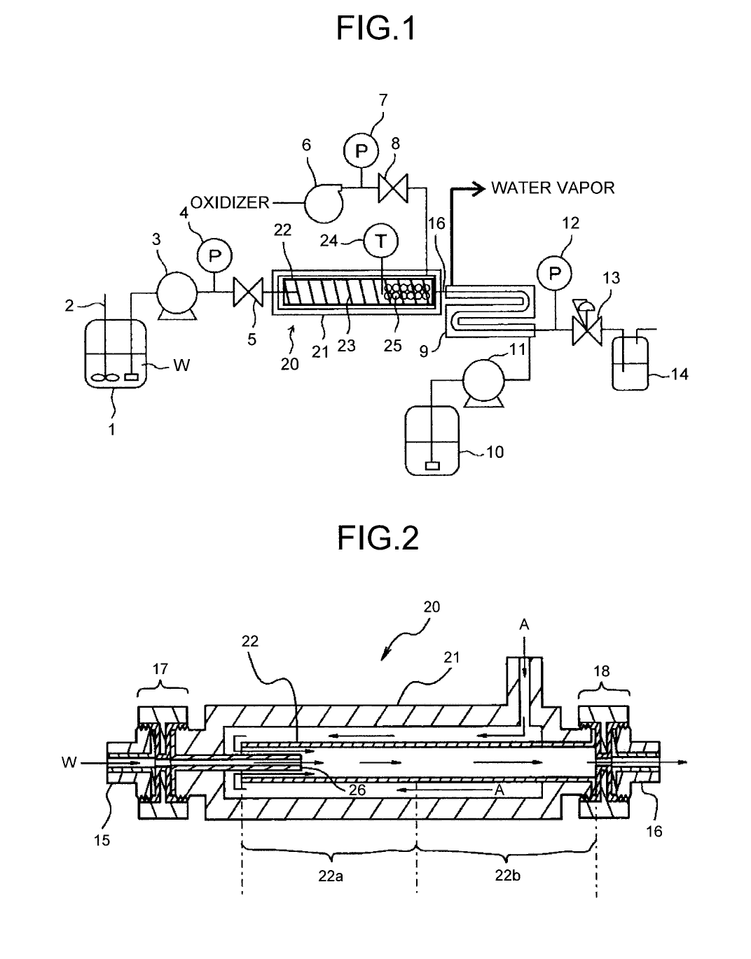

First, a basic configuration of the waste liquid treatment apparatus according to the embodiment will be described. FIG. 1 is a flow sheet illustrating the waste liquid treatment apparatus and a flow of treatment thereby according to the embodiment. The waste liquid treatment apparatus according to the embodiment is provided with a raw water tank 1, a stirring machine 2, a raw water supply pump 3, a raw water pressure gauge 4, a raw water inlet valve 5, an oxidizer pressure-feeding pump 6, an oxidizer pressure gauge 7, an oxidizer inlet valve 8, a heat exchanger 9, a heat medium tank 10, a heat exchange pump 11, an outlet pressure gauge 12, an outlet valve 13, a gas-liquid separator 14, a reaction vessel 20, a controller (not illustrated), and the like.

The controller has feeder circuits composed each of a combination of an earth leakage breaker, a magnet switch, a thermal relay, and the like, by a number sufficient to individually meet the respective demands of the stirring machine 2, the raw water supply pump 3, the oxidizer pressure-feeding pump 6, and the heat exchange pump 11. The magnet switch of the feeder circuit is turned on and off by a control signal from a programmable sequencer to individually control on and off of power supply to each of those devices.

Each of the raw water pressure gauge 4, the oxidizer pressure gauge 7, and the outlet pressure gauge 12 outputs a voltage having a value corresponding to a result of detection of pressure. A temperature gauge 24 of the reaction vessel 20 outputs a voltage corresponding to a result of detection of temperature. The voltages output from those measuring instruments are individually converted into digital data by respective A/D converters (not illustrated), and then entered as sensing data into the programmable sequencer. The programmable sequencer controls, based on those pieces of sensing data, controls drive of various devices.

Waste liquid W containing organic matter having a relatively large molecular weight is stored in an untreated state in the raw water tank 1. The waste liquid W is composed of at least one of organic solvent waste liquid, paper-making waste liquid generated in a paper-making process, and toner-manufacturing waste liquid generated in a toner-manufacturing process. The paper-making waste liquid and the toner-manufacturing waste liquid hardly contain ammonium nitrogen, but may contain persistent organic matter.

The stirring machine 2 stirs the waste liquid W as fluid to be treated, and thereby uniformly disperses suspended solids contained in the waste liquid so as to have a uniform concentration of the organic matter. The waste liquid W in the raw water tank 1 is continuously pressure-fed by the raw water supply pump 3 composed of a high-pressure pump, and thus flows under high pressure into the reaction vessel 20 via the raw water inlet valve 5. The inflow pressure of the waste liquid W driven by the raw water supply pump 3 is detected by the raw water pressure gauge 4, and entered as the sensing data into the programmable sequencer in the controller. The programmable sequence maintains the inflow pressure of the waste liquid W within a predetermined range by adjusting the drive amount of the raw water supply pump 3. The drive amount may be adjusted by turning on and off the raw water supply pump 3, or by changing the rotational speed of the raw water supply pump 3 with an inverter.

The oxidizer pressure-feeding pump 6 composed of a compressor takes in air as oxidizer, and, while compressing the air to a pressure approximately equal to the inflow pressure of the waste liquid W, feeds the air to the reaction vessel 20 via the oxidizer inlet valve 8. The inflow pressure of the air driven by the oxidizer pressure-feeding pump 6 is detected by the oxidizer pressure gauge 7, and entered as the sensing data into the programmable sequencer in the controller. The programmable sequence maintains the inflow pressure of the air within a predetermined range by adjusting the drive amount of the oxidizer pressure-feeding pump 6. The range is determined based on the stoichiometric amount of oxygen required to completely oxidize the organic matter in the waste liquid. More in detail, the amount of oxygen required to the complete oxidation is calculated based on the biochemical oxygen demand (BOD), the chemical oxygen demand (COD), the total nitrogen (TN), the total phosphorus (TP), and the like of the waste liquid, and also on the organic matter concentration, the nitrogen concentration, the phosphorus concentration, and the like of the waste liquid W, and, based on the calculation result, the control range of the inflow pressure of the air is set.

The control range of the inflow pressure of the air is set by a worker. However, if the type of the organic matter contained in the waste liquid W is stable through time, and if the correlation between physical properties, such as turbidity, light transmittance, and specific gravity, and the above-described amount of oxygen is relatively good, the programmable sequencer may be configured to perform processing of automatically correcting the above-described control range based on the results of detecting the physical properties with sensors or the like.

Not only the air but also any one of oxygen gas, ozone gas, and hydrogen peroxide solution, or a mixture of two or more of these types of material can be used as the oxidizer.

The waste liquid W as the fluid to be treated is in a liquid state until it is made to flow into the reaction vessel 20. However, after the waste liquid W is made to flow into the reaction vessel 20, water in the waste liquid turns, as will be described later, into a state of subcritical water or supercritical water, which differs from the state of liquid water. Then, after being discharged from the reaction vessel 20, the waste liquid W is separated into liquid and gas by the gas-liquid separator 14 while being rapidly cooled and decompressed.

FIG. 2 is a longitudinal sectional view illustrating the reaction vessel 20. The reaction vessel 20 has a double structure composed of an outer cylinder 21 and an inner cylinder 22 housed therein. A heater 23 for heating the waste liquid W is wound around the inner cylinder 22. The inner cylinder 22 is a cylinder made of titanium, which is highly resistant to acid. On the other hand, the outer cylinder 21 is a cylinder made of metallic material, such as stainless steel, excelling in strength. The pressure inside the reaction vessel 20 is controlled at a high pressure of 5 MPa to 30 MPa. The outer cylinder 21 has a large wall thickness so as to be resistible to such a high pressure. On the other hand, the inner cylinder 22 is required be resistant to corrosion rather than pressure, and therefore employs, as material, titanium, which exhibits excellent corrosion resistance.

The waste liquid W pressure-fed by the raw water supply pump (3 in FIG. 1) toward the reaction vessel 20 passes through the raw water inlet valve (5 in FIG. 1), and then enters an inlet pipe 15 connected to the outlet side of the raw water inlet valve. The inlet pipe 15 is connected to an inflow pipe 26 provided on the inlet side of the reaction vessel 20 with an inlet joint 17. In the reaction vessel 20, the waste liquid W pressure-fed from the inlet pipe 15 into the reaction vessel 20 passes through the inflow pipe 26, and flows into the inner cylinder 22. Then, the waste liquid W moves from the left side toward the right side in FIG. 2 in the inner cylinder 22 along the longitudinal direction thereof.

The air A pressure-fed by the oxidizer pressure-feeding pump 6 into the reaction vessel 20 flows into an inter-cylinder space between the outer cylinder 21 and the inner cylinder 22. Then, the air A moves from the right side toward the left side in FIG. 2 in the inter-cylinder space along the longitudinal direction thereof. The inner cylinder 22 is open at the left end thereof in FIG. 2, and the inflow pipe 26 for allowing the waste liquid W to flow into the inner cylinder 22 is inserted into the inner cylinder 22 through the opening thereof. A gap is formed between the outer wall of the inflow pipe 26 and the inner wall of the inner cylinder 22. Thus, the air A that has moved to the left end in FIG. 2 of the inter-cylinder space enters the inner cylinder 22 through the gap, and is mixed with the waste liquid W.

The inside of the inner cylinder 22 is at a high temperature in addition to being at a high pressure. The temperature thereof is 200° C. to 500° C. When the illustrated waste liquid treatment apparatus starts operating, the mixture of the waste liquid W and the air A in the inner cylinder 22 is subjected to a pressure, but remains at a not-so-high temperature. Accordingly, at the start of operation, the programmable sequencer makes the heater (23 in FIG. 1) generate heat so as to raise the temperature of the mixture in the inner cylinder 22 to a range of 200° C. to 550° C. As a result, the water in the waste liquid W inside the inner cylinder 22 turns into the subcritical water or the supercritical water, and thus, the organic matter in the fluid is rapidly hydrolyzed and oxidatively decomposed while being dissolved at a high rate. If the organic matter concentration of the waste liquid W is high to some degree, when the rapid oxidative decomposition of the organic matter is started in such a manner, the subcritical state or the supercritical state is maintained by itself by the heat generated by the oxidative decomposition. This is the same as the phenomenon in which, once alcohol or the like is ignited by using a match, the alcohol keeps burning from then until completely oxidatively decomposed. For this reason, the programmable sequencer makes the heater (23) generate heat only when needed based on the result of detection by the temperature gauge (24).

When the oxidative decomposition of the organic matter has been stared in the inner cylinder 22 and then the inner cylinder 22 is kept at a high temperature, the air A starts flowing into the inner cylinder 22 while being preheated in the inter-cylinder space between the inner cylinder 22 and the outer cylinder 21.

Hydrochloric acid derived from a chloro group of an organochloride or sulfuric acid derived from a sulfonyl group of an amino acid or the like can be temporarily produced in the inner cylinder 22, and thus, the inner wall of the inner cylinder 22 can be placed under a strong acidic condition. For this reason, the inner cylinder 22 employs the cylinder made of titanium, which excels in corrosion resistance. However, titanium is a very expensive material. Therefore, a very high cost is incurred by increasing the thickness of the inner cylinder 22 to a value large enough for the cylinder to be able to resist a high pressure. Otherwise, titanium is relatively low in strength under high-temperature environments. Therefore, there can be a case in which the strength capable of resisting a desired high pressure cannot be obtained under a desired high-temperature condition, regardless of how much the inner cylinder 22 is thickened. Accordingly, the outer cylinder 21 is arranged outside the inner cylinder 22 so that the necessary resistance to pressure is achieved by the outer cylinder 21 made of stainless steel or the like that is less expensive than titanium. The pressure-fed air A allows the inter-cylinder space between the inner cylinder 22 and the outer cylinder 21 to have almost the same pressure as the pressure in the inner cylinder 22. Therefore, the inner cylinder 22 made of thin-walled titanium is not subjected to a large pressure.

The treated fluid that has moved to near the right side end in FIG. 2 of the inner cylinder 22 has been placed in a state in which the organic matter and inorganic compounds are almost completely oxidatively decomposed. A feed pipe 16 for feeding the treated fluid that has been purified in the inner cylinder 22 is connected to the downstream-side end in the fluid feeding direction in the inner cylinder 22 with an outlet joint 18 interposed therebetween. The purified treated fluid enters the feed pipe 16.

In the feed pipe 16, the high-temperature treated fluid is cooled to turn into liquid. In the reaction vessel 20, the inner pressure of the inner cylinder 22 increases as a new supply of the waste liquid W flows into the inner cylinder 22 from the inflow pipe 26. Then, the pressure of liquid in the feed pipe 16 also increases. The outlet valve 13 composed of a back pressure valve is connected to an end of the feed pipe 16. When the pressure in the feed pipe 16 increases to above a threshold, the outlet valve 13 automatically opens to discharge the fluid in the feed pipe 16, and thereby keeps the pressure in the feed pipe 16 lower than the threshold. The fluid discharged by the outlet valve 13 from inside the feed pipe 16 is rapidly decompressed to near the atmospheric pressure, and thereby separates into treated liquid and gas. Then, the fluid is separated into the treated liquid and the gas by the gas-liquid separator 14, and the treated liquid is stored in a treated liquid tank. The gas is released into the atmosphere.

In the treated liquid, even very low-molecular organic matter that cannot be completely removed by biotreatment using activated sludge has been almost completely oxidatively decomposed. Therefore, the treated liquid hardly contains suspended solids or organic matter, and contains only very small amount of inorganic matter. The treated liquid can be reused as industrial water even as it is, depending on the purpose of use. The treated liquid can also be diverted to LSI cleaning liquid and the like by being treated with filtration treatment using ultrafiltration membranes. The gas separated by the gas-liquid separator 14 contains carbon dioxide and nitrogen as major components.

Next, a characteristic configuration of the waste liquid treatment apparatus according to the embodiment will be described.

In the reaction vessel 20, all reactions are carried out in the internal space of the inner cylinder 22, the reactions including converting the water in the waste liquid W into the subcritical water or the supercritical water, and completely oxidatively decomposing the substances contained in the subcritical water or the supercritical water. In the internal space of the inner cylinder 22, the components contained in the waste liquid W as the fluid to be treated flow together with the subcritical water or the supercritical water along the cylinder's longitudinal direction from the left side toward the right side in FIG. 2. The inner cylinder 22 in which the fluid flows in this manner is divided into two parts of a first decomposition reaction part 22a and a second decomposition reaction part 22b, both of which have the same diameter and are communicated with each other. The communicating portion between the two parts is neither narrowed nor connected by a pipe having a smaller inside diameter.

The first decomposition reaction part 22a is positioned on the upstream side in the fluid feeding direction relative to the second decomposition reaction part 22b. In the first decomposition reaction part 22a, the water in the waste liquid W is converted into the subcritical water or the supercritical water, and the organic matter in the fluid is low-molecularized by hydrolysis. In the waste liquid treatment apparatus according to the embodiment, the air serving as the oxidizer is supplied to the first decomposition reaction part 22a. Therefore, various compounds are also oxidatively decomposed in the first decomposition reaction part 22a. The oxidizer may be introduced only into the second decomposition reaction part 22b so that mainly the low-molecularization of compounds by hydrolysis is carried out in an intensive manner in the first decomposition reaction part 22a.

The organic matter and the ammonium nitrogen that have not been completely oxidatively decomposed is remaining at a certain degree of concentration in the subcritical water or the supercritical water passed through the first decomposition reaction part 22a. The second decomposition reaction part 22b is filled with particles supporting palladium on the surface thereof, as a catalyst (25 in FIG. 1) for facilitating the oxidative decomposition of the low-molecular organic matter and the ammonium nitrogen that have not been completely removed in the first decomposition reaction part 22a. In the second decomposition reaction part 22b, the treated fluid mixed with the air comes in contact with the catalyst under a high-temperature and high-pressure condition, and thereby, the low-molecular organic matter contained in the treated fluid is almost completely oxidatively decomposed.

In such a configuration, the first decomposition reaction part 22a and the second decomposition reaction part 22b in the single inner cylinder 22 are communicated with each other without being narrowed and without having a small-diameter pipe connecting between the two parts. Thus, there is no need for cleaning work of the pipe. With this configuration, ease of maintenance can be improved by making frequency of cleaning lower than is conventionally required.

It is preferable to use, as the catalyst for facilitating the oxidative decomposition of the low-molecular organic matter and the ammonium nitrogen, a catalyst containing at least any one element of Ru, Pd, Rh, Pt, Au, Ir, Os, Fe, Cu, Zn, Ni, Co, Ce, Ti, Mn, and C.

Depending on the types and concentrations of compounds contained in the waste liquid W, the catalyst (25) filled in the second decomposition reaction part 22b may be specialized for oxidative decomposition of low-molecular organic matter, or may be specialized for decomposition of ammonium nitrogen. Also, the first decomposition reaction part 22a may be filled with a catalyst different from the catalyst filled in the second decomposition reaction part 22b. Moreover, of the first decomposition reaction part 22a and the second decomposition reaction part 22b, only the first decomposition reaction part 22a may be filled with a catalyst. It is preferable to use, as the catalyst in this case, a catalyst specialized for hydrolyzing or oxidatively decomposing high-molecular organic matter into low-molecular organic matter. Furthermore, the oxidizer may be introduced only into the second decomposition reaction part 22b, and, after the organic matter is low-molecularized by hydrolysis in the first decomposition reaction part 22a, the organic matter may be oxidatively decomposed in the second decomposition reaction part 22b.

If the organic matter concentration in the waste liquid W is relatively high, the oxidative decomposition of the organic matter generates a large amount of heat. For this reason, as described above, although heating by the heater (23) is required at the initial stage of operation, the heat generated by the oxidative decomposition of the organic matter can be maintained by itself, depending on the organic matter concentration, a temperature equal to or higher than a temperature required to convert the water in the waste liquid W into the subcritical water or the supercritical water after the oxidative decomposition is started. Accordingly, when the result of detection of the temperature in the inner cylinder 22 by the temperature gauge (24) reaches the temperature equal to or higher than the temperature required for conversion into the subcritical water or the supercritical water, the programmable sequencer in the controller turns off the heater (23) serving as a heating unit. With this configuration, wasteful consumption of energy can be suppressed.

If the organic matter concentration in the waste liquid W is very high, the amount of heat generated by the oxidative decomposition of the organic matter can exceed an amount of heat required to raise the temperature of the waste liquid W newly flowing into the inner cylinder 22 to a predetermined temperature, and thus, if left as it is, the temperature in the inner cylinder 22 can continue rising. Accordingly, when the result of detection of the temperature in the inner cylinder 22 by the temperature gauge 24 reaches above a predetermined upper limit temperature, the programmable sequencer in the controller performs processing of reducing the feeding rate of feeding the waste liquid W to the first decomposition reaction part 22a by the raw water supply pump (3), or the supply rate of feeding the air A to the first decomposition reaction part 22a by the oxidizer pressure-feeding pump (6). With this configuration, the temperature in the inner cylinder 22 can be prevented from reaching above the upper limit temperature. If, as the heat exchanger 9 to be described later, such a heat exchanger is used that exchanges heat with the outer cylinder 21 in addition to with the feed pipe 16, the amount of heat exchange fluid fed to around the outer cylinder 21 may be increased instead of reducing the feeding amount of the waste liquid W or the air A.

In the waste liquid treatment apparatus according to the embodiment, as has already been described, the inter-cylinder space between the inner cylinder 22 and the outer cylinder 21 functions as an introduction passage that introduces the air A serving as the oxidizer into the inner cylinder 22. The air A that has flowed into the inter-cylinder space moves toward the inlet provided at the left end of the inner cylinder 22 while touching the outer wall of the inner cylinder 22. At this time, the heat generated in the first decomposition reaction part 22a and the second decomposition reaction part 22b of the inner cylinder 22 is transferred to the air A via the wall of the inner cylinder 22 so as to preheat the air A. In this manner, in the waste liquid treatment apparatus according to the embodiment, the wall of the inner cylinder 22 functions as a preheating unit that preheats the air A. In such a configuration, the heat generated in the inner cylinder 22 can be used for preheating the air A without externally supplying energy for preheating the air A.

The heat exchanger 9 is mounted on the outer wall of the feed pipe 16 that cools and feeds, toward the gas-liquid separator 14, the high-temperature and high-pressure fluid after being passed through the second decomposition reaction part 22b and treated. The body of the heat exchanger 9 composed of an outer tube covering the outer wall of the feed pipe 16, and the space between the outer tube and the outer wall of the feed pipe 16 is filled with heat exchange fluid such as water. Heat is exchanged between the outer wall of the feed pipe 16 and the heat exchange fluid. While the reaction vessel 20 is operating, very high-temperature fluid flows in the feed pipe 16. Therefore, heat transfers from the feed pipe 16 to the heat exchange fluid in the heat exchanger 9, and thus, the heat exchange fluid is heated. The feeding direction of the heat exchange fluid in the heat exchanger 9 is opposite to the feeding direction of the liquid in the feed pipe 16 so as to perform so-called countercurrent heat exchange. In other words, the heat exchange fluid is fed from the side of the outlet valve 13 toward the reaction vessel 20. This feeding is performed by the heat exchange pump 11 that suctions the heat exchange fluid from the heat medium tank 10 and feeds it to the heat exchanger 9. The heat exchange fluid heated by passing through the heat exchanger 9 is fed to an electric generator through a pipe (not illustrated). In the electric generator, a turbine is rotated by a gas flow generated when the heat exchange fluid at a pressure raised by heating turns from liquid into gas, and thereby, electric power is generated.

A part of the heat exchange fluid after passing through the heat exchanger 9 may be fed through a branch pipe to the inflow pipe 26 or up to the raw water tank 1 to be used for preheating the waste liquid W.

An outlet temperature gauge (not illustrated) that detects the temperature of the liquid in the feed pipe 16 is provided near the outlet valve 13 in the feed pipe 16. The programmable sequencer in the controller controls drive of the heat exchange pump 11 so as to maintain the result of detection by the outlet temperature gauge within a predetermined value range. Specifically, when the result of detection by the outlet temperature gauge reaches a predetermined upper limit temperature, the drive amount of the heat exchange pump 11 is increased to increase the amount of the heat exchange fluid supplied to the heat exchanger 9, and thus, the cooling function by the heat exchanger 9 is raised. On the other hand, when the result of detection by the outlet temperature gauge reaches a predetermined lower limit temperature, the drive amount of the heat exchange pump 11 is reduced to reduce the amount of the heat exchange fluid supplied to the heat exchanger 9, and thus, the cooling function by the heat exchanger 9 is lowered. In such a configuration, the temperature of the fluid in the feed pipe 16 can be maintained within a certain range by appropriately adjusting the amount of heat exchange.

In addition to, or instead of, mounting the heat exchanger 9 on the feed pipe 16, the heat exchanger 9 may be mounted on the outer cylinder 21 of the reaction vessel 20. In this case, by adjusting the amount of feed of the heat exchange fluid to around the outer cylinder 21 so as to keep the result of detection by the temperature gauge (24) within a predetermined range, the temperature in the inner cylinder 22 can be avoided from excessively rising and also from excessively dropping.

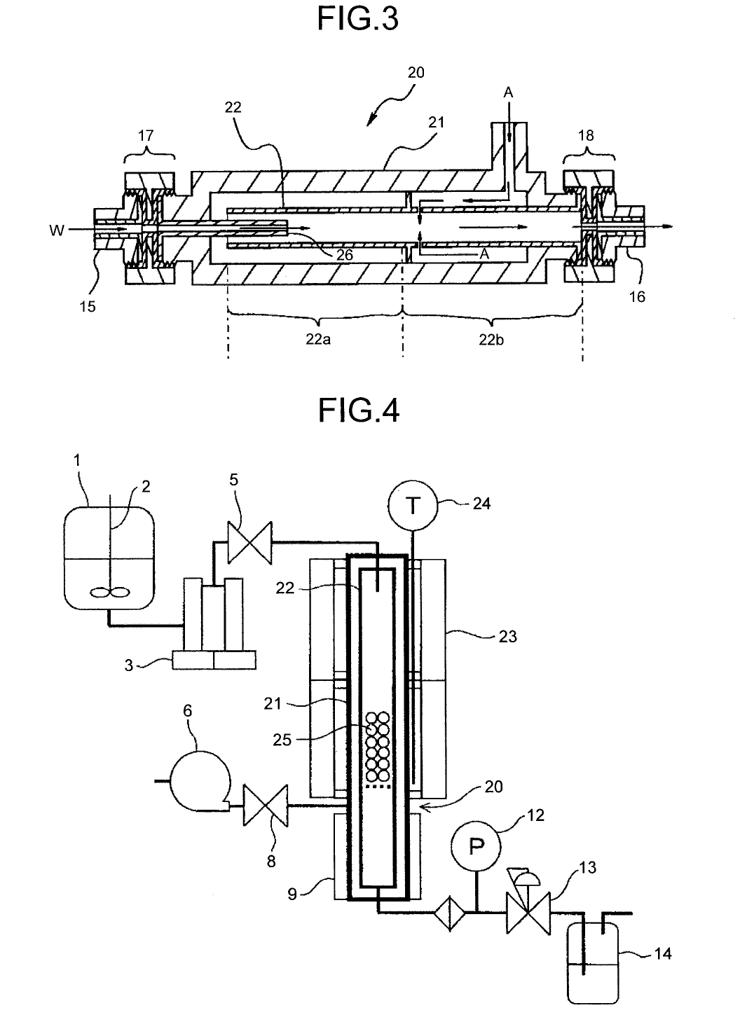

FIG. 3 is a longitudinal sectional view illustrating a reaction vessel 20 of a waste liquid treatment apparatus according to a first modification. In this reaction vessel 20, of a first decomposition reaction part 22a and a second decomposition reaction part 22b in an inner cylinder 22, only the second decomposition reaction part 22b is supplied with the air A pressure-fed into an inter-cylinder space between the inner cylinder 22 and an outer cylinder 21. In such a configuration, the organic matter can be low-molecularized in an intensive manner by hydrolysis, which requires no oxygen, in the first decomposition reaction part 22a, and thereafter, the low-molecularized organic matter and the ammonium nitrogen can be decomposed in an intensive manner in the second decomposition reaction part 22b.

FIG. 4 is a schematic configuration diagram illustrating a waste liquid treatment apparatus according to a second modification. In the waste liquid treatment apparatus according to the second modification, a cylindrical reaction vessel 20 is arranged in an attitude in which the cylinder's longitudinal direction is substantially aligned along the vertical direction so as to feed the fluid substantially along the vertical direction in the reaction vessel 20.

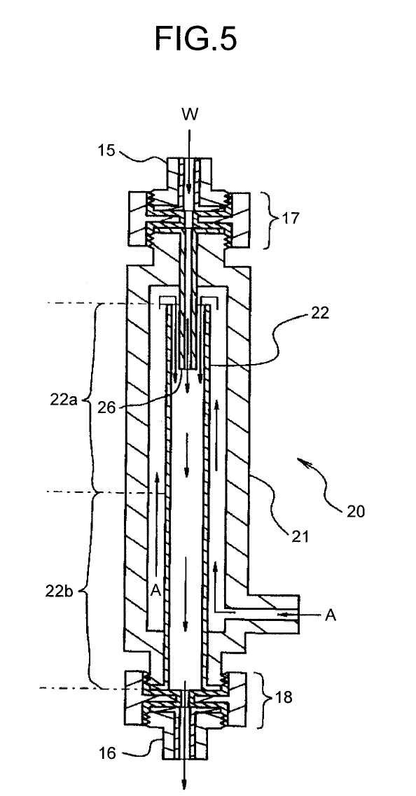

FIG. 5 is a longitudinal sectional view illustrating the reaction vessel 20 of the waste liquid treatment apparatus according to the second modification. In FIG. 5, in an internal space of an inner cylinder 22, the water in the waste liquid W that has flowed into the inner cylinder 22 flows from the upper side downward in the vertical direction while turning into the subcritical water or the supercritical water.

The inner cylinder 22 is divided into two parts of a first decomposition reaction part 22a and a second decomposition reaction part 22b, both of which have the same diameter and are communicated with each other. In the same manner as in cases of the embodiment and the first modification, the communicating portion between the two parts is neither narrowed nor connected by a pipe having a smaller inside diameter.

The descriptions given above are merely examples, and the present invention exhibits effects specific to the following respective aspects.

Aspect A

Aspect A is characterized in that a waste liquid treatment apparatus includes a first decomposition reaction part (such as 22a) that pressurizes and heats fluid to be treated, the fluid being composed of waste liquid containing organic matter, so as to at least hydrolyze or pyrolyze the organic matter in the fluid to be treated, and includes a second decomposition reaction part (such as 22b) that mixes the fluid to be treated after being passed through the first decomposition reaction part with an oxidizer while pressurizing and heating the fluid to be treated so as to oxidatively decompose the organic matter or inorganic matter in the fluid to be treated. Aspect A is also characterized in that, in the waste liquid treatment apparatus, the first decomposition reaction part and the second decomposition reaction part are arranged with respective catalysts of different types from each other, or, of the first decomposition reaction part and the second decomposition reaction part, only the second decomposition reaction part is arranged with a catalyst, and in that a fluid outlet side of the first decomposition reaction part and a fluid inlet side of the second decomposition reaction part are directly communicated with each other without being narrowed.

Aspect B

Aspect B is characterized in that, in Aspect A, a catalyst that facilitates the oxidative decomposition of the organic matter is used as the catalyst arranged in the second decomposition reaction part. In such a configuration, the organic matter in the fluid to be treated can be oxidatively decomposed satisfactorily while the fluid to be treated is placed in contact with the catalyst in the second decomposition reaction part.

Aspect C

Aspect C is characterized in that, in Aspect A or B, a catalyst that facilitates decomposition of ammonium nitrogen is used as the catalyst arranged in the second decomposition reaction part. In such a configuration, the ammonium nitrogen in the fluid to be treated can be satisfactorily decomposed while the fluid to be treated is placed in contact with the catalyst in the second decomposition reaction part.

Aspect D

Aspect D is characterized by including a heating unit (such as the heater 23) that heats the fluid to be treated in the first decomposition reaction part, a reaction temperature detection unit (such as the temperature gauge 24) that detects a temperature of the fluid to be treated in the first decomposition reaction part or the second decomposition reaction part, and a controller (such as the controller equipped with the programmable sequencer, and the like) that controls drive of the heating unit based on the result of detection by the reaction temperature detection unit. In such a configuration, as described above, in the case in which the temperature of the fluid to be treated in the decomposition reaction part can be raised to the required temperature by the heat generated by the oxidative decomposition of the organic matter in the fluid to be treated without being heated externally, generation of wasteful consumption of energy can be avoided by stopping the drive of the heating unit.

Aspect E

Aspect E is characterized by including, in Aspect D, a preheating unit that preheats at least one of the oxidizer and the waste liquid before being treated. In such a configuration, the hydrolysis of the organic matter can be brought about more quickly in the first decomposition reaction part by preheating the oxidizer or the waste liquid.

Aspect F

Aspect F is characterized by including, in Aspect E, an introduction passage that introduces the oxidizer into the first decomposition reaction part or the second decomposition reaction part while placing the oxidizer in contact with an outer wall of at least one of the first decomposition reaction part and the second decomposition reaction part, and is characterized in that the outer wall functions as the preheating unit that uses the heat of the first decomposition reaction part or the second decomposition reaction part to preheat the oxidizer in the introduction passage. In such a configuration, the oxidizer can be preheated without externally supplying special energy for preheating.

Aspect G

Aspect G is characterized in that, in Aspect E, the controller is configured to perform processing of controlling drive of the preheating unit based on the result of detection by the reaction temperature detection unit. In such a configuration, the temperatures of the first decomposition reaction part and the second decomposition reaction part can be adjusted to some extent by adjusting the temperature of the waste liquid supplied to the first decomposition reaction part.

Aspect H

Aspect H is characterized in that, in any one of Aspects D to G, the controller is configured to perform processing, based on the result of detection by the reaction temperature detection unit, of controlling a rate of feeding by a waste liquid feed unit (such as the raw water supply pump 3) that feeds the waste liquid as the untreated fluid to be treated to the first decomposition reaction part, or of controlling a rate of feeding by an oxidizer feed unit (such as the oxidizer pressure-feeding pump 6) that feeds the oxidizer to the first decomposition reaction part. In such a configuration, the temperatures of the first decomposition reaction part and the second decomposition reaction part can be adjusted to some extent by adjusting the amount of the waste liquid supplied per unit time to the first decomposition reaction part, or by adjusting the amount of the oxidizer supplied per unit time to the first decomposition reaction part or the second decomposition reaction part.

Aspect I

In any one of Aspects A to H, Aspect I is characterized by including a heat exchange unit (such as the heat exchanger 9) that causes heat exchange fluid to absorb heat from at least one of the first decomposition reaction part, the second decomposition reaction part, and a feed unit (such as the feed pipe 16) that feeds treated water after being treated by the second decomposition reaction part, and by including a heat exchange fluid feed unit (such as the heat exchange pump 11) that feeds the heat exchange fluid after exchanging the heat to an electric generation unit. In such a configuration, the treated fluid after being treated in the decomposition reaction parts can be quickly cooled by the heat exchange, and in addition, thermal energy obtained by the heat exchange can be used for electric generation, and thus can be reused as electrical energy.

Aspect J

In any one of Aspects A to H, Aspect J is characterized by including a heat exchange unit that causes heat exchange fluid to absorb heat from at least one of the first decomposition reaction part, the second decomposition reaction part, and a feed unit that feeds treated water after being treated by the second decomposition reaction part, and by including a heat exchange fluid feed unit that feeds the heat exchange fluid after exchanging the heat to the preheating unit preheating the oxidizer or the waste liquid. In such a configuration, the treated fluid after being treated in the decomposition reaction parts can be quickly cooled by the heat exchange, and in addition, thermal energy obtained by the heat exchange can be used for preheating the oxidizer or the waste liquid.

Aspect K

Aspect K is characterized by including, in Aspect I or J, a heat exchange fluid temperature detection unit that detects a temperature of the heat exchange fluid fed by the heat exchange fluid feed unit, and a controller that controls a rate of feed by the heat exchange fluid feed unit based on the result of detection by the heat exchange fluid temperature detection unit. In such a configuration, the temperature of the heat exchange fluid can be maintained within an appropriate range by adjusting the rate of feed of the heat exchange fluid after exchanging the heat.

Aspect L

Aspect L is characterized in that a waste liquid treatment method includes executing a first decomposition reaction step of pressurizing and heating fluid to be treated, the fluid being composed of waste liquid containing organic matter, so as to at least hydrolyze or pyrolyze the organic matter in the fluid to be treated, and a second decomposition reaction step of mixing the fluid to be treated after being subjected to the first decomposition reaction step with an oxidizer while pressurizing and heating the fluid to be treated so as to oxidatively decompose the organic matter or ammonium nitrogen in the fluid to be treated. Aspect L is also characterized in that, in the waste liquid treatment method, the first decomposition reaction step and the second decomposition reaction step are executed by using the waste liquid treatment apparatus according to any one of the aspects A to L.

Aspect M

Aspect M is characterized in that, in Aspect L, at least one of organic solvent waste liquid, paper-making waste liquid generated in a paper-making process, and toner-manufacturing waste liquid generated in a toner-manufacturing process is used as the waste liquid. In such a configuration, the organic matter contained in the organic solvent waste liquid, the paper-making waste liquid, or the toner-manufacturing waste liquid can be decomposed satisfactorily in the subcritical water or the supercritical water.

In the embodiments present invention, a catalyst of a type not arranged in a first decomposition reaction part facilitates decomposition of particular substances in a second decomposition reaction part, and thus, the substances that has not been completely removed in the first decomposition reaction part can be removed in the second decomposition reaction part in a surer manner. Alternatively, organic matter is not oxidatively decomposed but only low-molecularized by hydrolysis in the first decomposition reaction part that is not supplied with oxidizer, and then, the low-molecularized organic matter is oxidatively decomposed in the second decomposition reaction part that is supplied with oxidizer. Thus, the low-molecular organic matter that has not been completely removed in the first decomposition reaction part can be removed.

In addition, in the embodiments, an outlet side of the first decomposition reaction part and an inlet side of the second decomposition reaction part are directly communicated with each other without being narrowed, thus eliminating a pipe connecting the first decomposition reaction part and the second decomposition reaction part through an inside diameter smaller than inside diameters of the first and the second decomposition reaction parts. Thus, ease of maintenance can be improved by making cleaning work of the pipe unnecessary so as to reduce frequency of cleaning to lower than is conventionally required.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A waste liquid treatment apparatus comprising:
a first decomposition reaction part configured to pressurize and heat fluid to be treated, the fluid being composed of waste liquid containing organic matter, so as to at least hydrolyze or pyrolyze the organic matter in the fluid to be treated; and
a second decomposition reaction part configured to mix the fluid to be treated after being passed through the first decomposition reaction part with an oxidizer while pressurizing and heating the fluid to be treated so as to oxidatively decompose the organic matter or inorganic matter in the fluid to be treated, wherein
the first decomposition reaction part and the second decomposition reaction part are arranged with respective catalysts of different types from each other, or, of the first decomposition reaction part and the second decomposition reaction part, only the second decomposition reaction part is arranged with a catalyst, and
a fluid outlet side of the first decomposition reaction part and a fluid inlet side of the second decomposition reaction part are directly communicated with each other without being narrowed.

2. The waste liquid treatment apparatus according to claim 1, wherein a catalyst that facilitates the oxidative decomposition of the organic matter is used as the catalyst arranged in the second decomposition reaction part.

3. The waste liquid treatment apparatus according to claim 1, wherein a catalyst that facilitates decomposition of ammonium nitrogen is used as the catalyst arranged in the second decomposition reaction part.

4. The waste liquid treatment apparatus according to claim 1, further comprising:
a heating unit configured to heat the fluid to be treated in the first decomposition reaction part;
a reaction temperature detection unit configured to detect a temperature of the fluid to be treated in the first decomposition reaction part or the second decomposition reaction part; and
a controller configured to control drive of the heating unit based on a result of detection by the reaction temperature detection unit.

5. The waste liquid treatment apparatus according to claim 4, further comprising a preheating unit that preheats at least one of the oxidizer and the waste liquid.

6. The waste liquid treatment apparatus according to claim 5, further comprising:
an introduction passage that introduces the oxidizer into the first decomposition reaction part or the second decomposition reaction part while placing the oxidizer in contact with an outer wall of at least one of the first decomposition reaction part and the second decomposition reaction part, wherein
the outer wall functions as the preheating unit that uses heat of the first decomposition reaction part or the second decomposition reaction part to preheat the oxidizer in the introduction passage.

7. The waste liquid treatment apparatus according to claim 5, wherein the controller is configured to perform processing of controlling drive of the preheating unit based on the result of detection by the reaction temperature detection unit.

8. The waste liquid treatment apparatus according to claim 4, wherein the controller is configured to perform processing, based on the result of detection by the reaction temperature detection unit, of controlling a rate of feeding by a waste liquid feed unit that feeds the waste liquid as the fluid to be treated that is untreated to the first decomposition reaction part, or of controlling a rate of feeding by an oxidizer feed unit that feeds the oxidizer to the first decomposition reaction part.

9. The waste liquid treatment apparatus according to claim 1, further comprising:
a heat exchange unit configured to cause heat exchange fluid to absorb heat from at least one of the first decomposition reaction part, the second decomposition reaction part, and a feed unit that feeds treated water after being treated by the second decomposition reaction part; and
a heat exchange fluid feed unit configured to feed the heat exchange fluid after exchanging the heat to an electric generation unit.

10. The waste liquid treatment apparatus according to claim 1, further comprising:
a heat exchange unit configured to cause heat exchange fluid to absorb heat from at least one of the first decomposition reaction part, the second decomposition reaction part, and a feed unit that feeds treated water after being treated by the second decomposition reaction part; and
a heat exchange fluid feed unit configured to feed the heat exchange fluid after exchanging the heat to the preheating unit preheating the oxidizer or the waste liquid.

11. The waste liquid treatment apparatus according to claim 9, further comprising:
a heat exchange fluid temperature detection unit configured to detect a temperature of the heat exchange fluid fed by the heat exchange fluid feed unit; and
a controller configured to control a rate of feed by the heat exchange fluid feed unit based on the result of detection by the heat exchange fluid temperature detection unit.

12. The waste liquid treatment apparatus according to claim 10, further comprising:
a heat exchange fluid temperature detection unit configured to detect a temperature of the heat exchange fluid fed by the heat exchange fluid feed unit; and
a controller configured to control a rate of feed by the heat exchange fluid feed unit based on the result of detection by the heat exchange fluid temperature detection unit.

13. A waste liquid treatment method by using a waste liquid treatment apparatus that includes; a first decomposition reaction part configured to pressurize and heat fluid to be treated, the fluid being composed of waste liquid containing organic matter, so as to at least hydrolyze or pyrolyze the organic matter in the fluid to be treated; and a second decomposition reaction part configured to mix the fluid to be treated after being passed through the first decomposition reaction part with an oxidizer while pressurizing and heating the fluid to be treated so as to oxidatively decompose the organic matter or inorganic matter in the fluid to be treated, wherein the first decomposition reaction part and the second decomposition reaction part are arranged with respective catalysts of different types from each other, or, of the first decomposition reaction part and the second decomposition reaction part, only the second decomposition reaction part is arranged with a catalyst, and a fluid outlet side of the first decomposition reaction part and a fluid inlet side of the second decomposition reaction part are directly communicated with each other without being narrowed,
the waste liquid treatment method comprises:
pressurizing and heating fluid to be treated, the fluid being composed of waste liquid containing organic matter, so as to at least hydrolyze or pyrolyze the organic matter in the fluid to be treated; and
mixing the fluid to be treated after being subjected to the pressurizing and heating with an oxidizer while pressurizing and heating the fluid to be treated so as to decompose the organic matter or ammonium nitrogen in the fluid to be treated.

14. The waste liquid treatment method according to claim 13, wherein at least one of organic solvent waste liquid, paper-making waste liquid generated in a paper-making process, and toner-manufacturing waste liquid generated in a toner-manufacturing process is used as the waste liquid.
